(19) United States
(12) Patent Application Publication
(10) Pub. No.: US 2025/0363729 A1
(43) Pub. Date: Nov. 27, 2025

(54) GENERATION OF 3D ASSETS USING NOVEL POSE ESTIMATION

(71) Applicant: ALL3D, Inc., San Francisco, CA (US)

(72) Inventors: Kaiser Pister, Madison, WI (US); Amra Tareen, San Francisco, CA (US)

(21) Appl. No.: 18/671,805

(22) Filed: May 22, 2024

(51) Int. Cl. G06T 15/20; G06T 7/00; G06T 7/194; G06T 7/50

(52) U.S. Cl. CPC G06T 15/205; G06T 7/0002; G06T 7/194; G06T 7/50; G06T 2207/20081; G06T 2207/30168

(57) ABSTRACT

Implementations for generating a three-dimensional asset from a two-dimensional image of an object are provided. One aspect includes a computing system comprising processing circuitry and memory containing instructions that, when executed, cause the processing circuitry to receive an initial image of the object in a first perspective view; perform depth estimation on the initial image to generate depth information; generate a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object; and perform surface reconstruction using the plurality of novel view images to generate the three-dimensional asset.

### BACKGROUND

Three-dimensional (“3D”) digital assets—e.g., 3D computer models—are utilized in many different applications, including computer graphics, film, animation, video games, virtual reality/augmented reality, etc. Manual construction of these 3D assets can be costly in terms of skilled labor and time. Furthermore, artistic styles may differ greatly from one modeler to another. Techniques incorporating automated processes have been contemplated to provide more efficient and streamlined methods of generating 3D assets with consistent quality. Such techniques utilize various types of seed data, including two-dimensional (“2D”) images of objects. For example, some techniques involve capturing 2D images of a real-life object at different angles and utilizing appropriate software to combine information from different perspective views to reconstruct the object into a 3D computer model.

### SUMMARY

Implementations for generating a three-dimensional asset from a two-dimensional image of an object are provided. One aspect includes a computing system comprising processing circuitry and memory containing instructions that, when executed, cause the processing circuitry to receive an initial image of the object in a first perspective view; perform depth estimation on the initial image to generate depth information; generate a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and perform surface reconstruction using the plurality of novel view images to generate the three-dimensional asset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for generating a 3D asset from image data.

FIG. 2 shows an example latent diffusion-based generative model architecture, which can be implemented using the example computing system of FIG. 1.

FIG. 3 shows a flowchart depicting the data flow of an example method for generating a 3D asset from image data, which can be implemented using the example computing system of FIG. 1.

FIGS. 4A and 4B show example pipeline outputs at various steps of a method for generating a 3D asset from image data, such as the example method depicted in FIG. 3.

FIG. 5 shows a flowchart depicting the data flow of an example method for generating 3D assets for individual components of an object from image data, which can be implemented using the example computing system of FIG. 1.

FIG. 6 shows example pipeline outputs at various steps of a method for generating 3D assets for individual components of an object from image data, such as the example method depicted in FIG. 5.

FIG. 7 shows a flowchart detailing steps of an example method for generating a 3D asset from image data, which can be implemented using the example computing system of FIG. 1.

FIG. 8 shows a flowchart detailing steps of an example method for generating 3D assets for individual components of an object from image data, which can be implemented using the example computing system of FIG. 1.

FIG. 9 shows a schematic view of an example computing environment that can enact one or more of the methods and processes described herein.

### DETAILED DESCRIPTION

Many techniques have been contemplated for generating 3D digital assets. Generally, these techniques utilize appropriate software and methodologies to combine multiple 2D images of an object at different perspective views to construct a 3D asset of the object. For example, stereo reconstruction algorithms can utilize multi-view images to perform 3D reconstruction. However, obtaining such images of sufficiently high quality and volume for the construction of a 3D asset can be difficult, tedious, and costly. One class of techniques involves moving a camera around a real-life object and capturing numerous images at different perspective views. The images can be inconsistent in quality if performed by a user, and the methodology can be prohibitive due to the required labor. More recent techniques include utilizing machine learning models for the generation of multi-view images used to construct a 3D asset and, in some cases, for the construction of the 3D asset. However, such techniques generally focus on efficiency and the robustness of the input data, which enables the generation of a large number of 3D assets but leads to inconsistent and low-quality assets.

In view of the observations above, example techniques are provided for constructing a 3D asset of an object from 2D image data of the object using a structured framework. The use of a structured framework can enable production of high-quality assets that are more consistent with reality compared to conventional methods. Briefly, a structured framework according to the disclosed examples includes the generation of estimated novel view images from one or more initial 2D images of an object that is to be reconstructed as a 3D asset. The novel view images provide information from various perspective views of the object to enable reconstruction of the object as a 3D asset. Various constraints can be enforced on the generation of novel view images to provide enhanced consistency in the images, which leads to consistency in the quality of the 3D asset. In some implementations, the novel view images are generated to have perspective views in accordance with a predefined arrangement. For example, the novel view images can be generated to have perspective views that are spaced uniformly in an imaginary unit sphere around the object. This uniformity enables consistency in the reconstruction of the object into a 3D asset. The framework can further include other avenues of information to provide a more accurate reconstruction. For example, the framework can include a depth estimation step where depth information is determined for the initial 2D image data, which can be used to enhance accuracy for the generation of the novel view images.

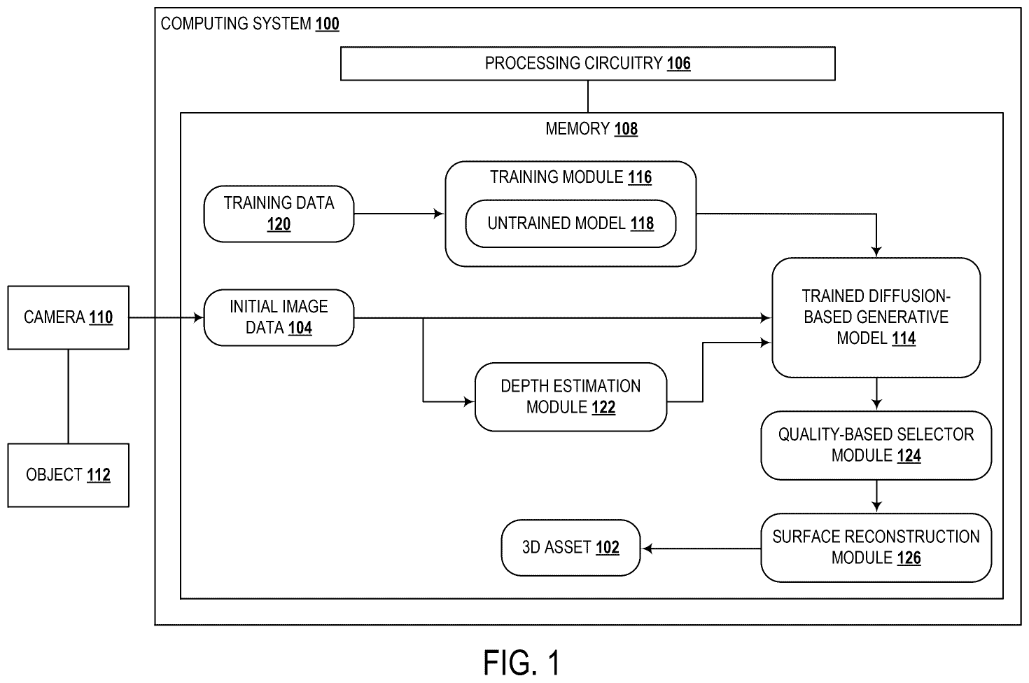

Turning now to the drawings, techniques for constructing a 3D asset of an object from 2D image data of the object are depicted and described in further detail. FIG. 1 shows a schematic view of an example computing system 100 for generating a 3D asset 102 from image data 104. The computing system 100 includes processing circuitry 106 (e.g., central processing units, or “CPUs”) coupled to memory 108 storing instructions that, when executed by the processing circuitry 106, cause the processing circuitry 106 to perform the various steps described herein. The computing system 100 can further include other components (not shown) providing various functions (e.g., an input/output (I/O) module, a display, etc.).

The process for generating the 3D asset 102 starts with receiving initial image data 104. The initial image data 104 can be received from various sources. For example, the initial image data 104 can be provided by a user, through local storage or externally over a network. In the depicted example, the initial image data 104 is received from an external camera device 110 configured to image an object 112 that is to be reconstructed into the 3D asset 102. The initial image data 104 can include any number of images of any image file format. In some implementations, the initial image data 104 includes a single 2D image of the object 112. In other implementations, the initial image data 104 includes a plurality of 2D images of the object, each image containing a different perspective view of the object 112. Multiple images may result in a more accurate reconstruction of the 3D asset 102 but can be more difficult to obtain.

The process further includes feeding the initial image data 104 into a diffusion-based generative model 114 that is trained to estimate a novel view image (an image with a different perspective view) from a given input image. The trained model 114 can be provided in various ways. In the depicted example, the system 100 includes a training module 116 for training an untrained model 118 using training data 120. The trained model can then be implemented as the trained diffusion-based generative model 114. In other implementations, the trained diffusion-based generative model 114 is imported into the computing system 100. Training data 120 can be tailored depending on the application. For example, the training data 120 can include sets of training images tailored to teach the untrained model 118 to estimate and generate novel view images. In some implementations, the training data 120 includes a plurality of training data sets, each training data set including a plurality of training images with different perspective views of a training object. In further implementations, each training data set includes training images with perspective views evenly-spaced in two dimensions in an imaginary unit sphere around the respective training object. As the model 118 is trained with such consistent data, it learns to estimate similar data for a given input image. In other words, for a given input image, evenly-spaced novel view images can be generated with consistent quality. Other types of training data sets can also be utilized. In some implementations, each training data set includes training images with different perspective views of a respective object corresponding to a sixteen-by-nine grid of points on an imaginary unit sphere around the respective training object.

The initial image data 104 can be fed into the trained diffusion-based generative model 114 to generate a plurality of novel view images. Alterations and/or additional inputs can be utilized depending on the application. In some implementations, a background removal process is performed on the initial image data 104 before it is fed into the trained diffusion-based generative model 114. Depth information can also be used by the model 114 to provide enhanced accuracy. In the depicted example, a depth estimation module 122 is implemented to process the initial image data 104 to determine the depth information for the image, or images, in the initial image data 104. The depth estimation module 116 can be implemented in various ways. For example, a neural network model can be implemented to estimate depth in a 2D image. The estimated depth information can be formatted in various ways. In some implementations, the depth information is provided as a grayscale image with grayscale values corresponding to the pixel-by-pixel depth relative to the camera.

In some implementations, the trained diffusion-based generative model 114 generates a plurality of novel view images with a predefined arrangement of perspective views. The novel view images can be generated to have different perspective views facing an origin point corresponding to the object. In some implementations, the different perspective views correspond to points on an imaginary unit sphere around the object organized with similar angular distances between neighboring points across two axes. For example, neighboring points along a line on the imaginary sphere are uniformly separated with similar angular distances. The predefined arrangement of perspective views can include various layout schemes.

In some implementations, the predefined arrangement includes perspective views corresponding to angular distances evenly-spaced on the imaginary unit sphere. Non-uniformly spaced angular distances can also be utilized. In some implementations, the novel view images have different perspective views corresponding to a grid, overlaid on an imaginary unit sphere around the object, of different angular distances across a first axis and different angular distances across a second axis. Grids of any size can be utilized. In some implementations, the grid includes at least four-by-three points, resulting in at least twelve perspective views. In further implementations, the grid includes at least sixteen-by-nine points, resulting in at least one hundred forty-four different perspective views. As can readily be appreciated, the predefined arrangement can mirror the arrangement of the perspective views in the training data used to train the trained diffusion-based generative model 114.

Grids overlaid on an imaginary unit sphere can be formed from circles on the imaginary unit sphere. As such, a predefined arrangement of perspective views can include perspective views corresponding to intersecting points formed from circles on the imaginary unit sphere around the object. In some implementations, the predefined arrangement includes perspective views corresponding to intersecting points formed from evenly spaced circles across a first axis and evenly spaced small circles across a second axis. The circles can include great circles and small circles. For example, the perspective views can correspond to intersecting points formed from longitudes and latitudes. Any number of circles can be implemented to describe any number of perspective views to be included in the predefined arrangement. In some implementations, the predefined arrangement includes at least twelve perspective views corresponding to intersecting points of circles on the imaginary unit sphere. In further implementations, the predefined arrangement includes one hundred forty-four perspective views corresponding to intersecting points of sixteen longitudes and nine latitudes.

Generating the plurality of novel view images can be performed in various ways. In some implementations, a single image from the initial image data 104 is fed through the trained diffusion-based generative model 114 for a predetermined number of times to generate a predetermined number of novel view images. In some implementations, a generated novel view image is fed back into the trained diffusion-based generative model 114 to generate successive novel view images. For example, an initial image can be fed through the trained diffusion-based generative model 114 to generate a first novel view image, and the first novel view image can be fed through the model 114 to generate a second novel view image. The process can be repeated until a predetermined number of novel view images is generated. In some implementations, a combination of the two methods described above is utilized. Any predetermined number of novel view images can be utilized. In some implementations, one hundred forty-four novel view images are generated (e.g., in a sixteen-by-nine arrangement).

In some implementations, the trained diffusion-based generative model 114 can be conditioned to generate a novel view image with a given perspective view. For example, the model 114 can be conditioned to generate a novel view image with a perspective view of a given delta (e.g., angular distance) relative to the perspective view of the input image, where the two views are on the same imaginary unit sphere around the object. This can provide enhanced accuracy in cases where an output novel view image is used as an input for generating successive images (e.g., estimating a novel view with a 20 degrees delta rotation can be less accurate compared to estimating a novel view with a 10 degrees delta rotation and then estimating a second novel view with a further 10 degrees delta rotation using the first novel view image).

In some implementations, the process is configured to over-generate the number of novel view images for reconstructing the 3D asset 102 than is desired. Over-generating the number of novel view images can enable selective use of higher-quality images to reconstruct a more accurate 3D asset 102. In the depicted example, the system 102 further includes a quality-based selector module 124 for selecting a subset from the plurality of novel view images based on at least one quality criterion. Other criteria can also be utilized. For example, the generated novel view images can be scored for similarity, and such scoring can be utilized as the criteria for selecting the subset (e.g., more consistent quality images can result in a higher-quality 3D asset reconstruction). The selector module 124 can be implemented in various ways. In some implementations, the selector module 124 includes a machine learning model trained with reinforcement learning to select the subset based on a quality criterion. In other implementations, the subset is selected manually by a user.

Selection of the subset can depend on the make up of the novel view images. In some implementations, the plurality of novel view images contains an over-generated number of perspective views. In such cases, selection of the subset can reduce the number of perspective views. In some implementations, the generated plurality of novel view images includes pluralities of similar view images, where each plurality of similar view images includes the same perspective view of the object. As the diffusion-based generative model 114 is a probabilistic model, similar view images may vary in quality across iterations despite having the same input. In such cases, selection of the subset can include selecting one or more images from each of the plurality of similar view images (e.g., based on quality).

The system 100 further includes a surface reconstruction module 126 for reconstructing the 3D asset 102 using the generated novel view images, or subset of the generated novel view images. The surface reconstruction module 126 generates the 3D asset 102 by attempting to determine where the surfaces of the object are based on the novel view images. Various surface reconstruction techniques can be utilized, including any stereo reconstruction and multi-view object reconstruction methodologies. In some implementations, a joint reconstruction process is performed using information from the surface reconstruction of the novel view images and a direct surface reconstruction methodology using the initial image data 104. The direct surface reconstruction process can be implemented, for example, using a diffusion-based model that takes a 2D image and generates a 3D model.

Diffusion-based generative models, such as the diffusion-based generative model 114 of FIG. 1, are denoising diffusion probabilistic models designed to approximate the probability densities of training data via the reversed processes of Markovian forward Gaussian diffusion processes. The probabilistic model can be taught to mimic the distribution from which the training data are sampled. The parameterized reversed process of the denoising diffusion probabilistic model can be interpreted as iteratively removing noise signals to recover clean signals. In some applications, the efficiency of the diffusion-based generative model can be improved by implementing the use of a latent diffusion architecture that models the data distribution in a low-dimensional latent space. Denoising noisy data in a lower dimension may reduce the computational cost in the generation process.

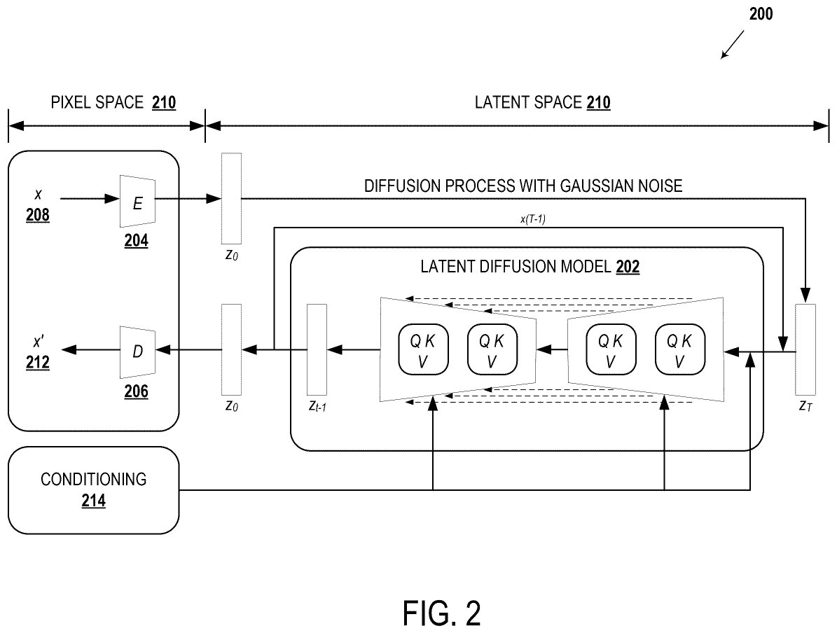

FIG. 2 shows an example latent diffusion-based generative model architecture 200. The example architecture 200 includes a latent diffusion model 202 with a time-conditional U-Net backbone with cross-attention layers (Q, K, V). The example architecture 200 further includes a pre-trained variational auto-encoder (VAE) model E-D. The encoder 204 and decoder 206 of the variational auto-encoder are denoted by [symbol] and [symbol] respectively. The architecture 200 can be implemented by first training the autoencoder [symbol] - [symbol] to map images into a low-dimensional space and to reconstruct images from latent codes [symbol] . During the training phase, input images x 208 in pixel space 210 are projected into a learned latent space [symbol] 212 via the encoder 204 (given an image x, encoder [symbol] encodes x into a latent representation z= [symbol] (x)). A diffusion process is performed to corrupt the input images x 208 with a time step t sampled from {1, . . . , T}. The latent diffusion model 202 is trained to predict a denoised variant of the corrupted images. Decoder [symbol] 206 reconstructs the image from the latent and produces generated image x′ 212. The example architecture 200 further includes a conditioning mechanism 214 that can condition the latent diffusion model 202 via concatenation or via the cross-attention layers through various inputs, including text, images, semantic maps, etc.

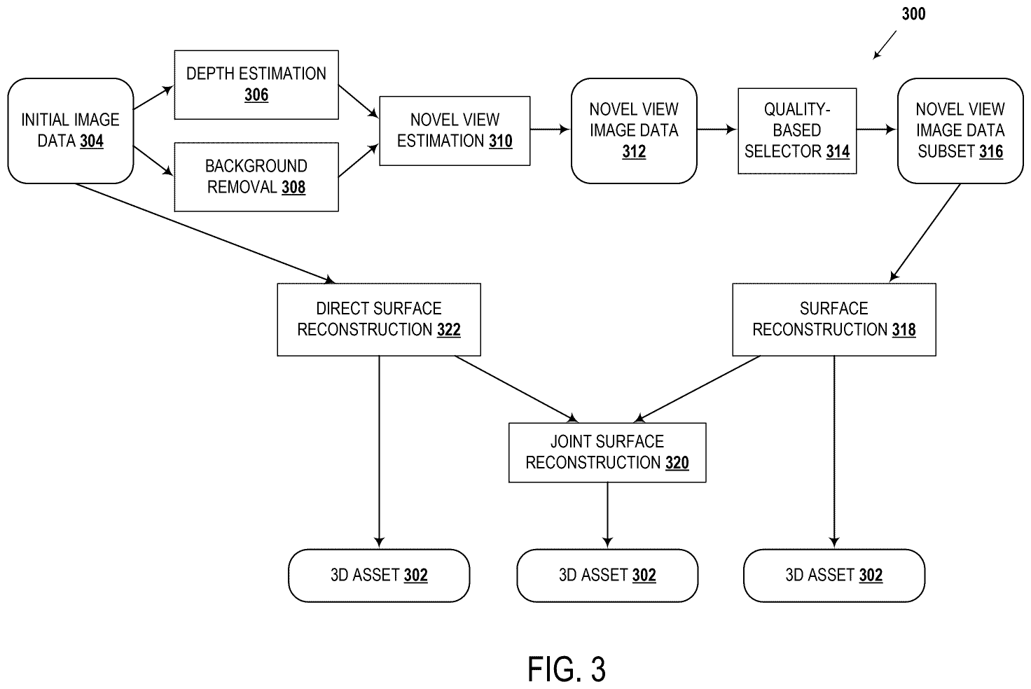

A trained diffusion-based generative model, such as one obtained through the example architecture 200 discussed in FIG. 2, can be implemented in various ways for the generation of 3D assets. FIG. 3 shows a flowchart depicting the data flow of an example method 300 for generating a 3D asset 302 from image data 304. The depicted example method 300 can be implemented, for example, using the hardware components described in FIG. 1. The method 300 starts with receiving initial image data 304 that includes one or more images of an object (similar to the initial image data 104 of FIG. 1). The method 300 includes a depth estimation step 306 that can be performed on the initial image data 304 to determine depth information, which can be used by the diffusion-based generative model to more accurately generate novel view images. The depth information can be formatted in various ways. In some implementations, the depth information is a grayscale version of the initial image data 304, where grayscale values correspond to depth information on a pixel-by-pixel basis.

The method 300 further includes a background removal step 308 that can be performed on the initial image data 304 to remove the background, leaving only the object behind. The background-removed images and the depth information are used in a novel view estimation step 310 to generate novel view image data 312, which includes images of the object in perspective views different than the one(s) in the initial image data 304. The novel pose estimation step 310 can be performed, for example, using the trained diffusion-based generative model 114 discussed above with respect to FIG. 1. In method 300, the novel view images 312 are over-generated, and a subset selection step 314 is performed to reduce the number of novel view images 312 to a desired number. In the depicted example, the subset selection step 314 selects the novel view image data subset 316 based on a quality criterion. Any other criteria can be utilized. In some implementations, the subset selection step 314 is performed using a machine learning model. In other implementations, the subset selection step 314 is performed via user selection.

The method 300 further includes a surface reconstruction 318 step. Surface reconstruction 318 can be performed on the novel view image data subset 316 to generate a 3D asset 302 of the object. Another surface reconstruction step 322 can be performed using a direct methodology on the initial image data 304 to generate a 3D asset 302. For example, a diffusion-based model can be utilized to transform the initial image data 304 directly into a 3D asset. In the depicted example, a joint surface reconstruction step 320 is performed where the surface reconstruction 318 performed using the novel view image data subset 316 is utilized in combination with the other surface reconstruction step 322 to generate a 3D asset 302. The various methodologies described can be used as alternatives or in combination to provide a 3D asset. For example, 3D assets of the components of the object can be generated using different methodologies and combined to form a 3D asset of the object.

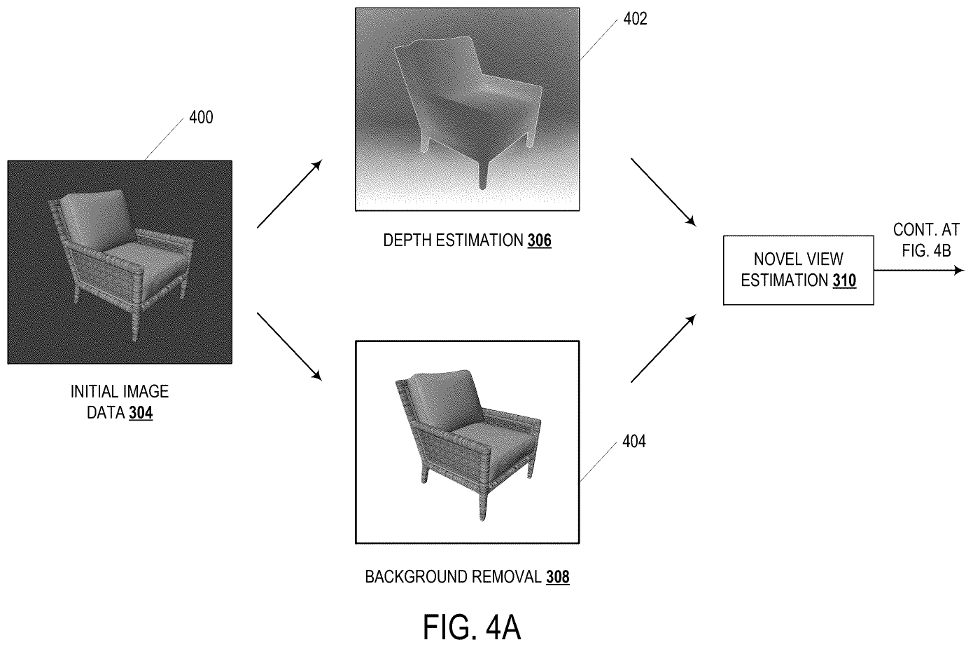

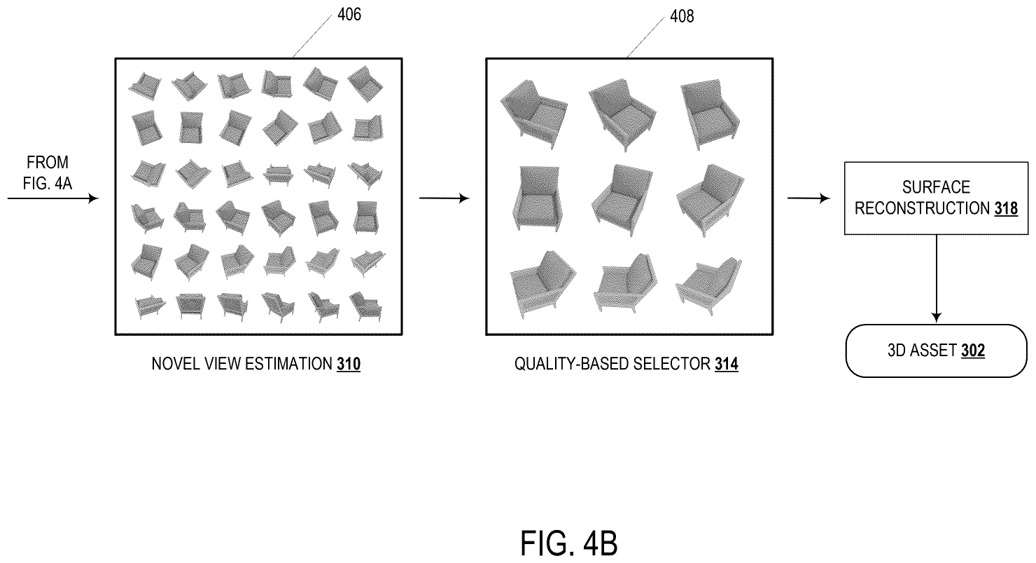

FIGS. 4A and 4B show example pipeline outputs at various steps of a method for generating a 3D asset from image data. In the depicted example, the pipeline outputs correspond to the method 300 of FIG. 3. Initial image 400 corresponds, for example, to the initial image data 304 depicted and discussed in FIG. 3. As shown, initial image 400 is a 2D image of a chair. The pipeline outputs further include a depth image 402 resulting from, for example, the depth estimation step 306 of FIG. 3. The depth image 402 is a grayscale image where each pixel value indicates the estimated depth at the pixel location relative to the camera. In parallel, the pipeline outputs include a background-removed image 404 resulting from, for example, the background removal step 308 of FIG. 3. As shown, the background-removed image 404 depicts the same chair of the initial image 400 but with the background removed. The background can be replaced with transparent alpha values. Together with the depth map 402, the background-removed image 404 can be utilized in the novel view estimation step 310 to generate a plurality of novel view images 406. In the depicted example, the plurality of novel view images 406 includes thirty-six images, each with a different perspective view of the chair object. At the subset selection step 314, the pipeline outputs include a subset of novel view images 408, which includes nine of the original thirty-six images in the plurality of novel view images 406.

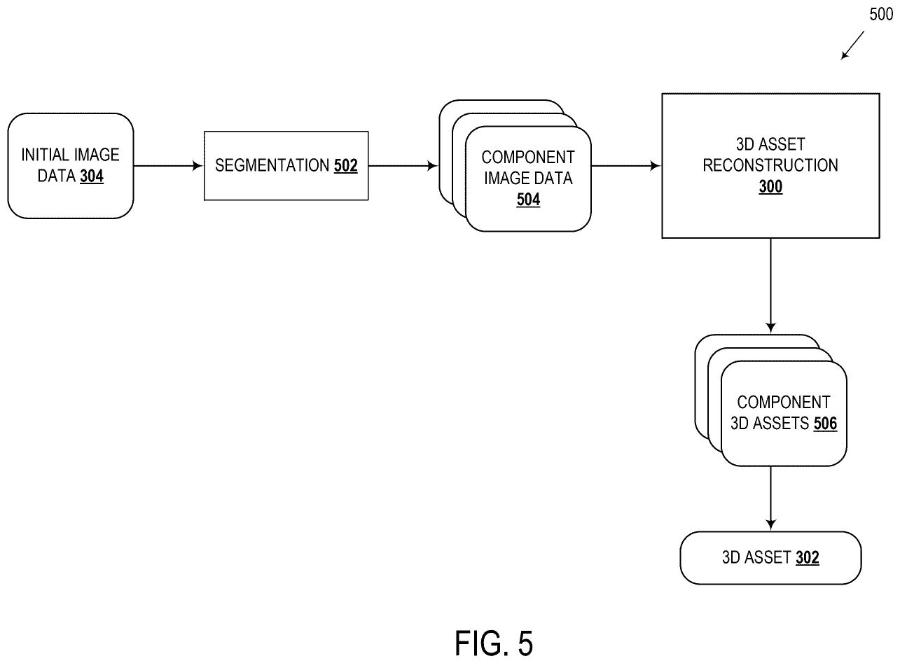

FIG. 5 shows a flowchart 500 depicting the data flow of an example method 500 for generating 3D assets for individual components of an object from image data. The depicted example method 500 can be implemented, for example, using the hardware components described in FIG. 1. The example method 500 starts with initial image data 304, similar to the example method 300 of FIG. 3. The method 500 includes a segmentation step 502 where the depicted object of the initial image data 304 is segmented into a plurality of components. The segmentation step 502 outputs component image data 504, which includes a plurality of images that each represent an isolated component.

For each image (component) in the component image data 504, the 3D asset reconstruction method 300 described in FIG. 3 can be performed to reconstruct a 3D asset of the component. The 3D asset reconstruction method 300 can be performed similarly as described above. Instead of reconstructing an object from a single image, a plurality of component 3D assets 506 are reconstructed from a plurality of component images 504. The plurality of component 3D assets 506 can be combined to form the 3D asset 302 representing the object.

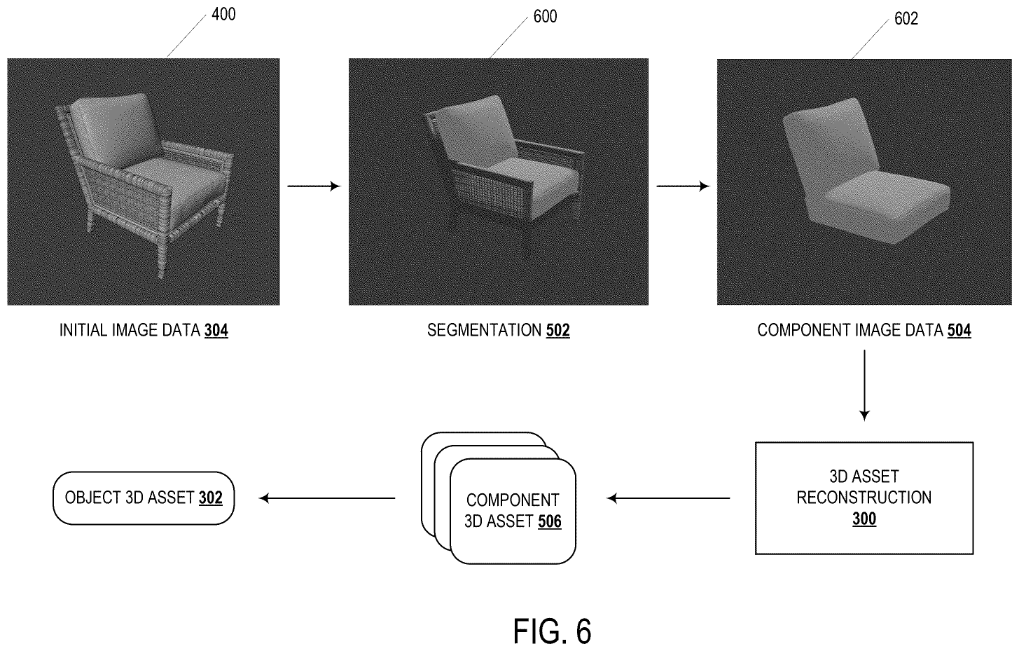

FIG. 6 shows example pipeline outputs at various steps of a method for generating 3D assets for individual components of an object from image data. In the depicted example, the pipeline outputs correspond to the method 500 of FIG. 5. Initial image 400 corresponds, for example, to the initial image data 304 depicted and discussed in FIGS. 3 and 5. As shown, initial image 400 is a 2D image of a chair. At the segmentation step 502, the initial image 400 is segmented to isolate various components of the object. In the depicted example, the segmented image 600 shows cushions of the chair as highlighted, illustrating that the cushions of the chair are isolated as a component. Segmented image 600 illustrates isolation of one component. However, the segmentation step 502 can segment the entirety of the object into a plurality of components. For example, another segmented image may show that the legs of the chair are isolated as another component. The components are isolated into individual images. In the depicted example, component image 602 illustrates an isolated cushions component of the chair in initial image 400. Images of each isolated component can be grouped to form the component image data 504 of FIG. 5.

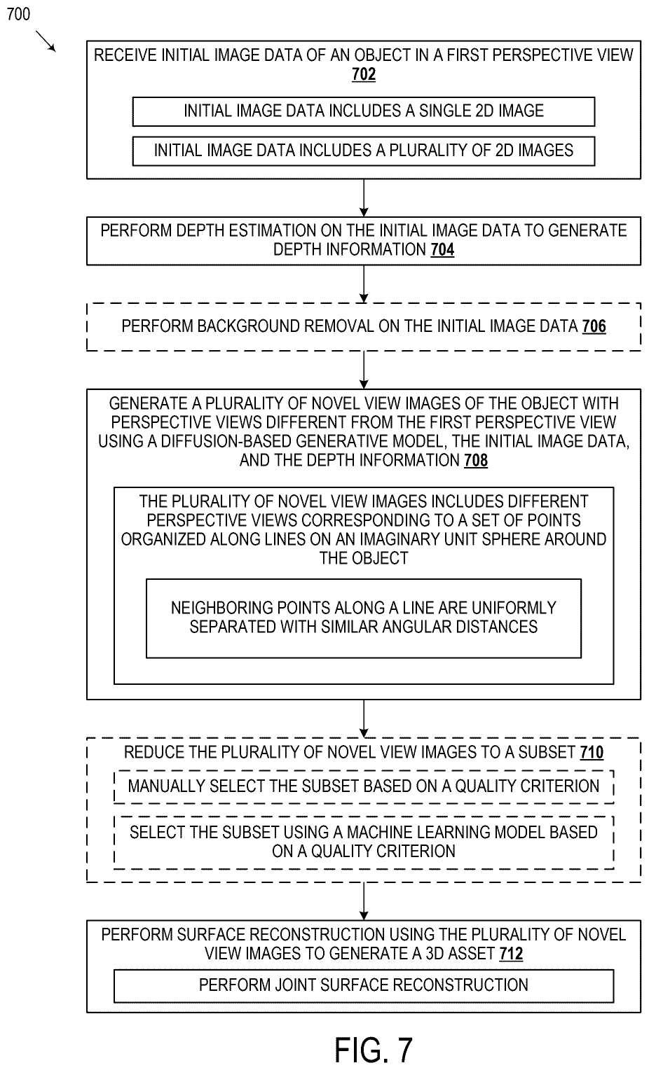

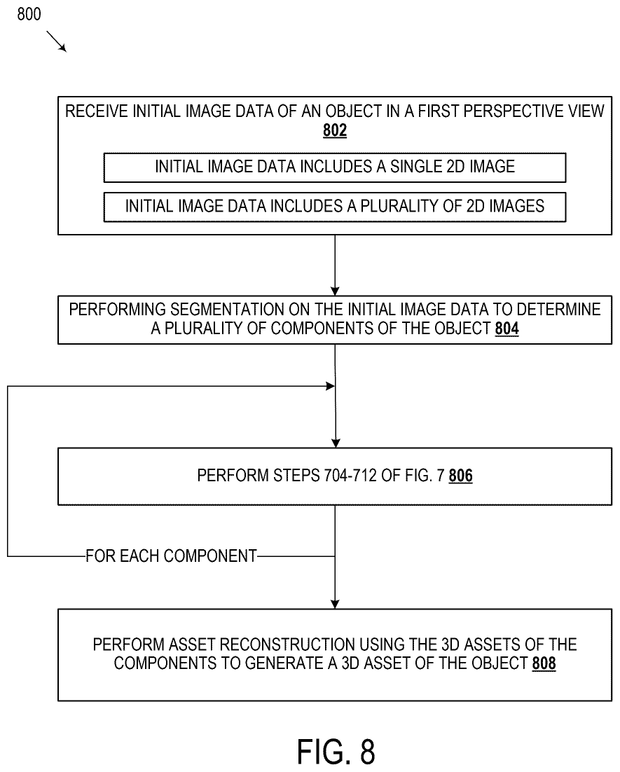

FIG. 7 shows a flowchart detailing steps of an example method 700 for generating a 3D asset from image data. The method 700 includes, at step 702, receiving initial image data of an object in a first perspective view. In some implementations, the initial image data includes a single 2D image of the object. In other implementations, the initial image data includes a plurality of 2D images of the object, which can be of the same or different perspective views. The initial image data can be received in various ways, including through local storage, external devices, over a network, etc.

The method 700 further includes, at step 704, performing depth estimation on the initial image data to generate depth information. Depth estimation can be performed in various ways. In some implementations, a machine learning model is implemented to estimate depth from a 2D image of the initial image data. The depth information can be formatted and provided in various ways. In some implementations, the depth information is formatted as a depth map with pixels containing grayscale values. The grayscale values represent the estimated depth at each pixel location relative to the camera.

The method 700 further includes, at step 706, optionally performing background removal on the initial image data. Background removal can be implemented in various ways. In some implementations, a segmentation model trained to classify background and foreground pixels is implemented to perform the background removal of the initial image data.

The method 700 further includes, at step 708, generating a plurality of novel view images of the object with perspective views different from the first perspective view using a diffusion-based generative model, the initial image data, and the depth information. The plurality of novel view images can be generated in various ways. In some implementations, a single initial image is passed through the diffusion-based generative model a predetermined number of times, each time conditioned with a different perspective view, to generate the plurality of novel view images. Another method includes using a first generated novel view image as input into the diffusion-based generative model to generate the second novel view image (conditioned with a delta rotation in perspective view), and so on until a predetermined number of novel view images is generated. The plurality of novel view images can be generated to have predetermined perspective views. In some implementations, the plurality of novel view images includes different perspective views corresponding to points on a grid of overlaid on an imaginary unit sphere around the object. In further implementations, the grid is a sixteen-by-nine grid. The grid can be of any size. In some implementations, the different perspective views correspond to angular distances evenly-spaced across two axes.

The method 700 further includes, at step 710, optionally reducing the plurality of novel view images to a subset. The subset can be of any size. In some implementations, the subset includes 50% or less images than the plurality of novel view images. The subset of novel view images can be selected in various ways. In some implementations, the subset is manually selected by a user. In other implementations, the subset is selected using a machine learning model configured to select images based on a quality criterion. Any criteria can be utilized in the selection process. For example, the plurality of novel view images can be scored for similarity, and images with higher similarity scores can be selected. The selection process can also depend on the content of the plurality of novel view images. For example, in some implementations, the plurality of novel view images includes pluralities of similar view images. Each plurality of similar view images includes the same perspective view of the object. In such cases, the subset selection process can include selecting one (or more in some cases) image for each of the pluralities of similar view images.

The method 700 further includes, at step 712, performing surface reconstruction using the plurality (or subset) of novel view images to generate a 3D asset of the object. In some implementations, a joint surface reconstruction is performed where a first surface reconstruction is performed using the plurality (or subset) of novel view images and a second surface reconstruction is performed using a direct methodology. The two surface reconstructions are utilized jointly to generate the 3D asset. In some implementations, the second surface reconstruction is performed using an initial 2D image and a diffusion-based model that attempts to generate a corresponding 3D asset using only the initial 2D image.

FIG. 8 shows a flowchart detailing steps of an example method 800 for generating 3D assets for individual components of an object from image data. The method 800 includes, at step 802, receiving initial image data of an object in a first perspective view. Step 802 can be performed similarly as step 702 of the example method 700 depicted in FIG. 7.

The method 800 further includes, at step 804, performing segmentation on the initial image data to determine various components that make up the object. The segmentation can be performed in various ways. In some implementations, a machine learning model configured for image segmentation is implemented to perform the segmentation. The method 800 further includes, at step 806, repeating steps 704-712 of the method 700 for generating a 3D asset from image data depicted in FIG. 7. Step 806 can be performed for each component of the object, resulting in a plurality of component 3D assets. The method 800 further includes, at step 808, performing asset reconstruction using the plurality of component 3D assets. The asset reconstruction combines the individual 3D assets of the components to form a 3D asset of the object.

In some embodiments, the methods and processes described herein may be tied to a computing system of one or more computing devices. In particular, such methods and processes may be implemented as a computer-application program or service, an application-programming interface (API), a library, and/or other computer-program product.

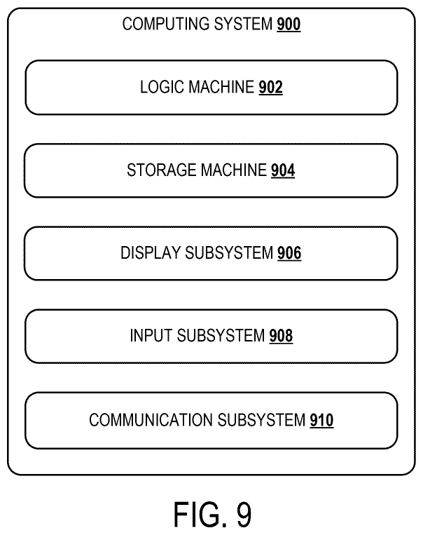

FIG. 9 schematically shows a non-limiting embodiment of a computing system 900 that can enact one or more of the methods and processes described above. Computing system 900 is shown in simplified form. Computing system 900 may embody the computing system 100 described above and illustrated in FIG. 1, respectively. Components of computing system 900 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 900 includes processing circuitry 902, volatile memory 904, and a non-volatile storage device 906. Computing system 900 may optionally include a display subsystem 908, input subsystem 910, communication subsystem 912, and/or other components not shown in FIG. 9.

Processing circuitry 902 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 902 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 902.

Non-volatile storage device 906 includes one or more physical devices configured to hold instructions executable by the processing circuitry to implement the methods and processes described herein. When such methods and processes are implemented, the state of non-volatile storage device 906 may be transformed—e.g., to hold different data.

Non-volatile storage device 906 may include physical devices that are removable and/or built in. Non-volatile storage device 906 may include optical memory, semiconductor memory, and/or magnetic memory, or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by processing circuitry 902 to temporarily store information during processing of software instructions. It will be appreciated that volatile memory 904 typically does not continue to store instructions when power is cut to the volatile memory 904.

Aspects of processing circuitry 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via processing circuitry 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a GUI. As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with processing circuitry 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, camera, or microphone.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 900 to send and/or receive messages to and/or from other devices via a network such as the Internet.

The following paragraphs provide additional description of the subject matter of the present disclosure. One aspect provides a computing system for generating a three-dimensional asset of an object, the computing system comprising processing circuitry and memory containing instructions that, when executed, cause the processing circuitry to: receive an initial image of the object in a first perspective view; perform depth estimation on the initial image to generate depth information; generate a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and perform surface reconstruction using the plurality of novel view images to generate the three-dimensional asset. In this aspect, additionally or alternatively, the instructions, when executed, further cause the processing circuitry to segment the initial image to isolate a component of the object, wherein the plurality of novel view images comprises images of the component, and wherein the generated three-dimensional asset comprises a three-dimensional asset of the component. In this aspect, additionally or alternatively, the instructions, when executed, further cause the processing circuitry to perform background removal on the initial image, wherein the plurality of novel view images is generated using the diffusion-based generative model, the background-removed initial image, and the depth information. In this aspect, additionally or alternatively, the perspective views of the plurality of novel view images are different perspective views corresponding to a second set of points on an imaginary unit sphere around the object, wherein the second set of points is organized along lines on the imaginary unit sphere around the object. In this aspect, additionally or alternatively, the plurality of novel view images comprises one hundred forty-four images with different perspective views corresponding to intersecting points of a grid of sixteen lines in a first axis and nine lines in a second axis on an imaginary unit sphere around the object. In this aspect, additionally or alternatively, the instructions, when executed, further cause the processing circuitry to select a subset of the plurality of novel view images, wherein the surface reconstruction is performed using the selected subset, exclusive of the novel view images outside the selected subset. In this aspect, additionally or alternatively, the subset is selected based on at least a quality criterion using a machine learning model trained with reinforcement learning. In this aspect, additionally or alternatively, the plurality of novel view images comprises pluralities of similar view images, each plurality of similar view images corresponding to a respective perspective view of the object, and wherein selecting the subset of the plurality of novel view images comprises, for each plurality of similar view images, selecting an image based on at least a quality criterion. In this aspect, additionally or alternatively, performing the surface reconstruction comprises: performing a first surface reconstruction using the subset of the plurality of novel view images; performing a second surface reconstruction using a direct methodology based on the initial image; and performing a joint reconstruction using the first surface reconstruction and the second surface reconstruction to generate the three-dimensional asset. In this aspect, additionally or alternatively, each of the plurality of training data sets is generated using a training three-dimensional asset corresponding to a respective training object.

Another aspect provides a method for generating a three-dimensional asset of an object, the method comprising: receiving an initial image of the object in a first perspective view; performing depth estimation on the initial image to generate depth information; generating a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and performing surface reconstruction using the plurality of novel view images to generate the three-dimensional asset. In this aspect, additionally or alternatively, the method further comprises segmenting the initial image to isolate a component of the object, wherein the plurality of novel view images comprises images of the component, and wherein the generated three-dimensional asset comprises a three-dimensional asset of the component. In this aspect, additionally or alternatively, the method further comprises performing background removal on the initial image, wherein the plurality of novel view images is generated using the diffusion-based generative model, the background-removed initial image, and the depth information. In this aspect, additionally or alternatively, the perspective views of the plurality of novel view images are different perspective views corresponding to a second set of points on an imaginary unit sphere around the object, wherein the second set of points is organized along lines on the imaginary unit sphere around the object. In this aspect, additionally or alternatively, the plurality of novel view images comprises one hundred forty-four images with different perspective views corresponding to intersecting points of a grid of sixteen lines in a first axis and nine lines in a second axis on an imaginary unit sphere around the object. In this aspect, additionally or alternatively, the method further comprises selecting a subset of the plurality of novel view images, wherein the surface reconstruction is performed using the selected subset, exclusive of the novel view images outside the selected subset. In this aspect, additionally or alternatively, the plurality of novel view images comprises pluralities of similar view images, each plurality of similar view images corresponding to a respective perspective view of the object, and wherein selecting the subset of the plurality of novel view images comprises, for each plurality of similar view images, selecting an image based on at least a quality criterion. In this aspect, additionally or alternatively, performing the surface reconstruction comprises: performing a first surface reconstruction using the subset of the plurality of novel view images; performing a second surface reconstruction using a direct methodology based on the initial image; and performing a joint reconstruction using the first surface reconstruction and the second surface reconstruction to generate the three-dimensional asset. In this aspect, additionally or alternatively, each of the plurality of training data sets is generated using a training three-dimensional asset corresponding to a respective training object.

Another aspect provides a method for generating a three-dimensional asset of an object, the method comprising: receiving an initial image of the object in a first perspective view; segmenting the initial image to isolate a plurality of components of the object; for each of the plurality of components: performing depth estimation on the component to generate depth information; generating a plurality of novel view images of the component with perspective views different from the first perspective view using a diffusion-based generative model, the component, and the depth information of the component, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and performing surface reconstruction of the component using the plurality of novel view images to generate a three-dimensional asset of the component; and performing asset reconstruction using the three-dimensional assets of the plurality of components to generate the three-dimensional asset of the object.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a three-dimensional asset of an object, the computing system comprising:
processing circuitry and memory containing instructions that, when executed, cause the processing circuitry to:
receive an initial image of the object in a first perspective view;
perform depth estimation on the initial image to generate depth information;
generate a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and
perform surface reconstruction using the plurality of novel view images to generate the three-dimensional asset.

2. The computing system of claim 1, wherein the instructions, when executed, further cause the processing circuitry to:
segment the initial image to isolate a component of the object, wherein the plurality of novel view images comprises images of the component, and wherein the generated three-dimensional asset comprises a three-dimensional asset of the component.

3. The computing system of claim 1, wherein the instructions, when executed, further cause the processing circuitry to:
perform background removal on the initial image, wherein the plurality of novel view images is generated using the diffusion-based generative model, the background-removed initial image, and the depth information.

4. The computing system of claim 1, wherein the perspective views of the plurality of novel view images are different perspective views corresponding to a second set of points on an imaginary unit sphere around the object, wherein the second set of points is organized along lines on the imaginary unit sphere around the object.

5. The computing system of claim 1, wherein the plurality of novel view images comprises one hundred forty-four images with different perspective views corresponding to intersecting points of a grid of sixteen lines in a first axis and nine lines in a second axis on an imaginary unit sphere around the object.

6. The computing system of claim 1, wherein the instructions, when executed, further cause the processing circuitry to:
select a subset of the plurality of novel view images, wherein the surface reconstruction is performed using the selected subset, exclusive of the novel view images outside the selected subset.

7. The computing system of claim 6, wherein the subset is selected based on at least a quality criterion using a machine learning model trained with reinforcement learning.

8. The computing system of claim 6, wherein the plurality of novel view images comprises pluralities of similar view images, each plurality of similar view images corresponding to a respective perspective view of the object, and wherein selecting the subset of the plurality of novel view images comprises, for each plurality of similar view images, selecting an image based on at least a quality criterion.

9. The computing system of claim 6, wherein performing the surface reconstruction comprises:
performing a first surface reconstruction using the subset of the plurality of novel view images;
performing a second surface reconstruction using a direct methodology based on the initial image; and
performing a joint reconstruction using the first surface reconstruction and the second surface reconstruction to generate the three-dimensional asset.

10. The computing system of claim 1, wherein each of the plurality of training data sets is generated using a training three-dimensional asset corresponding to a respective training object.

11. A method for generating a three-dimensional asset of an object, the method comprising:
receiving an initial image of the object in a first perspective view;
performing depth estimation on the initial image to generate depth information;
generating a plurality of novel view images with perspective views different from the first perspective view using a diffusion-based generative model, the initial image, and the depth information, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and
performing surface reconstruction using the plurality of novel view images to generate the three-dimensional asset.

12. The method of claim 11, further comprising:
segmenting the initial image to isolate a component of the object, wherein the plurality of novel view images comprises images of the component, and wherein the generated three-dimensional asset comprises a three-dimensional asset of the component.

13. The method of claim 11, further comprising:
performing background removal on the initial image, wherein the plurality of novel view images is generated using the diffusion-based generative model, the background-removed initial image, and the depth information.

14. The method of claim 11, wherein the perspective views of the plurality of novel view images are different perspective views corresponding to a second set of points on an imaginary unit sphere around the object, wherein the second set of points is organized along lines on the imaginary unit sphere around the object.

15. The method of claim 11, wherein the plurality of novel view images comprises one hundred forty-four images with different perspective views corresponding to intersecting points of a grid of sixteen lines in a first axis and nine lines in a second axis on an imaginary unit sphere around the object.

16. The method of claim 11, further comprising:
selecting a subset of the plurality of novel view images, wherein the surface reconstruction is performed using the selected subset, exclusive of the novel view images outside the selected subset.

17. The method of claim 16, wherein the plurality of novel view images comprises pluralities of similar view images, each plurality of similar view images corresponding to a respective perspective view of the object, and wherein selecting the subset of the plurality of novel view images comprises, for each plurality of similar view images, selecting an image based on at least a quality criterion.

18. The method of claim 16, wherein performing the surface reconstruction comprises:
performing a first surface reconstruction using the subset of the plurality of novel view images;
performing a second surface reconstruction using a direct methodology based on the initial image; and
performing a joint reconstruction using the first surface reconstruction and the second surface reconstruction to generate the three-dimensional asset.

19. The method of claim 11, wherein each of the plurality of training data sets is generated using a training three-dimensional asset corresponding to a respective training object.

20. A method for generating a three-dimensional asset of an object, the method comprising:
receiving an initial image of the object in a first perspective view;
segmenting the initial image to isolate a plurality of components of the object;
for each of the plurality of components:
performing depth estimation on the component to generate depth information;
generating a plurality of novel view images of the component with perspective views different from the first perspective view using a diffusion-based generative model, the component, and the depth information of the component, wherein the diffusion-based generative model has been trained with a plurality of training data sets, each training data set comprising a plurality of training images with different perspective views corresponding to a set of points on an imaginary unit sphere around a training object, wherein the set of points is organized along lines on the imaginary unit sphere around the training object such that neighboring points along a line are uniformly separated with similar angular distances; and
performing surface reconstruction of the component using the plurality of novel view images to generate a three-dimensional asset of the component; and
performing asset reconstruction using the three-dimensional assets of the plurality of components to generate the three-dimensional asset of the object.
